(19) United States
(12) Patent Application Publication
(10) Pub. No.: US 2025/0004713 A1
(43) Pub. Date: Jan. 2, 2025

(54) HARDWARE-IMPLEMENTED DEEP FRACTION POLYNOMIAL EVALUATION

(71) Applicant: INTERNATIONAL BUSINESS MACHINES CORPORATION, ARMONK, NY (US)

(72) Inventors: ROBERT FREDERICK ENENKEL, MARKHAM (CA); CHRISTOPHER ANAND, DUNDAS (CA); SILVIA MELITTA MUELLER, ST. INGBERT (DE); YU-SHIUAN WU, NEWMARKET (CA)

(21) Appl. No.: 18/345,062

(22) Filed: Jun. 30, 2023

(51) Int. Cl. G06F 7/483; G06F 7/544

(52) U.S. Cl. CPC G06F 7/483; G06F 7/5443

(57) ABSTRACT

Hardware-implemented deep fraction polynomial evaluation includes receiving a floating-point input value to be input to a function with an approximation that includes a polynomial, and converting the floating-point input value to a fixed-point representation including a whole number portion, a leading fraction bits portion, and a remaining fraction bits portion. A first result is computed based on the whole number portion and the leading fraction bits portion using a first computation operation. A second result is computed based on the remaining fraction bits portion using a second computation operation, the second computation operation using a single fixed-point multiply-add instruction defining one or more fused multiply-add operations including a predetermined number of bit shifts with predetermined shift amounts. An output value of the function is computed based on the first result and the second result.

### BACKGROUND

### Field of the Disclosure

The field of the disclosure is data processing, or, more specifically, methods, apparatus, and products for hardware-implemented deep fraction polynomial evaluation.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

The performance of data processing applications such as artificial intelligence (AI), analytics, and databases often depends upon a small number of important mathematical functions used for computation. For AI applications, linear operations are important and are often performed using specialized hardware accelerators. As a result, non-linear functions are often dominant in terms of execution time of algorithms including basic arithmetic functions (e.g., divide) and specialized functions (e.g., activation functions such as sigmoid). Many mathematical functions are approximated using polynomials as a result of the existence of a number of approximation methods that utilize polynomials such as Taylor polynomials, Legendre polynomials, and minmax approximations. However, a challenge exists to accelerate polynomial evaluation for the widest range of applications.

A standard approach to polynomial evaluation is to use Horner's rule which evaluates polynomials as a nested series of multiply-add operations. Horner's rule minimizes the number of instructions, but because the instructions form a single long-dependency chain, exhibits poor latency. Some alternative approaches may have shorter latency, but utilize more instructions. In both cases, these floating-point calculations are computationally expensive by using a power-hungry unit (e.g., a floating-point computation unit) on a typical central processing unit (CPU). Accelerators exist for approximating specific functions, including linear algebra which can be used for complex function approximation. However, these accelerators target specific functions and aren't suitable for more general polynomial evaluation. Accordingly, existing approaches to polynomial evaluation are either expensive in terms of computational requirements (e.g., area, latency, or power), target only specific functions, or both.

### SUMMARY

Methods, apparatus and systems for hardware-implemented deep fraction polynomial evaluation according to an embodiment include receiving a floating-point input value to be input to a function with an approximation that includes a polynomial; and converting the floating-point input value to a fixed-point representation including a whole number portion, a leading fraction bits portion, and a remaining fraction bits portion. The embodiment further includes computing a first result based on the whole number portion and the leading fraction bits portion using a first computation operation. The method further includes computing a second result based on the remaining fraction bits portion using a second computation operation, the second computation operation using a single fixed-point multiply-add instruction defining one or more fused multiply-add operations including a predetermined number of bit shifts with predetermined shift amounts. The method still further includes computing an output value of the function based on the first result and the second result.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 is a block diagram of automated computing machinery comprising an exemplary computing system configured for a multi-table approach to floating-point function approximation according to embodiments of the present disclosure.

FIG. 2 is a flowchart of an example method for deep fraction polynomial evaluation according to embodiments of the present disclosure.

FIG. 3 shows an example of a hardware instruction for deep fraction polynomial evaluation according to embodiments of the present disclosure.

FIG. 4 is a flowchart of another example method for deep fraction polynomial evaluation according to some embodiments of the present disclosure.

### DETAILED DESCRIPTION

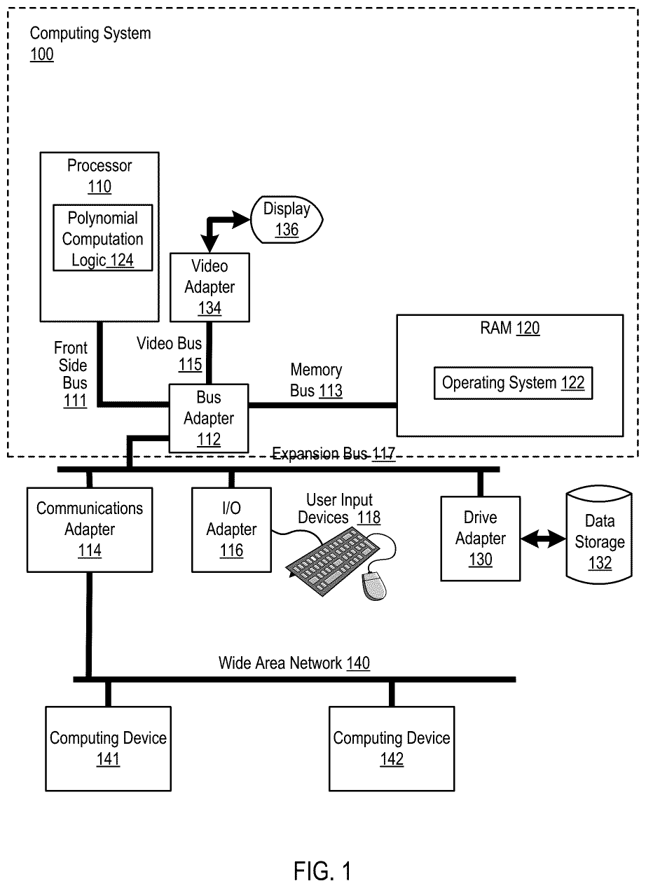

Exemplary apparatus and systems for hardware-implemented deep fraction polynomial evaluation in accordance with the present disclosure are described with reference to the accompanying drawings, beginning with FIG. 1. FIG. 1 sets forth a block diagram of automated computing machinery comprising an exemplary computing system 100 configured for deep fraction polynomial evaluation according to embodiments of the present disclosure. The term “deep fraction” refers to a method in which a bit field deep into the fraction part (i.e., to the right of the more significant bits) is extracted and used in a fixed-point or floating-point computation. In accordance with various embodiments, it is used in a polynomial. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100. The processor 110 includes polynomial computation logic 124 configured to perform hardware-implemented deep fraction polynomial evaluation according to various embodiments described herein. In one or more embodiments, polynomial computation logic 124 is implemented in hardware utilizing hardware logic such as logic gates. In particular embodiments, the polynomial computation logic 124 may be utilized by applications such as AI, analytic, or database applications. Although the polynomial computation logic 124 is shown in the embodiment of FIG. 1 as being located within the processor 110, in other embodiments the polynomial computation logic 124 is located within RAM 20.

Stored in RAM 120 is an operating system 122. Operating systems useful in computers configured for function approximation according to embodiments of the present disclosure include UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (‘I/O’) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1.

As discussed above, existing approaches to polynomial evaluation are either expensive in terms of computational requirements (e.g., area, latency, or power), target only specific functions, or both. One or more embodiments provide for a faster way of computing polynomials under two constraints: (1) the polynomial coefficients are fractions whose numerators and denominators are sums of small numbers of powers of two as further discussed below; and (2) the input to the polynomial is a small number, e.g., |x|< 1/256. These constraints are satisfied for most common elementary mathematical functions used for computation. Under these conditions, in various embodiments a sequence of floating-point operations used for polynomial evaluation is replaced by fixed-size bit shifts and concatenation, and in some cases, simple additions. In one or more embodiments, these operations are combined into a single instruction which would otherwise require execution of multiple instructions.

Accordingly, various embodiments provide for reduced instruction count and allows for more compact hardware implementation. For example, in the case of evaluating a polynomial of (1+x+(½)x²), a particular implementation uses a single modified fused multiply-add (FMA) instruction to compute a third-order polynomial. In contrast, using existing approaches that utilize Horner's rule requires two FMA operations to compute the polynomial. An FMA is a floating-point multiply-add operation performed in one step with a single rounding operation to compute an expression of the form a+(b×c). An unfused multiply-add computes the product b×c, rounds the result to M significant digits, adds the result to a, and rounds back to M significant digits. A fused multiply-add operation on the other hand computes the entire expression a+(b×c) to its full precision before rounding the final result down to M significant digits. In the particular implementation, latency and power consumption are cut in half. In an alternative implementation, the polynomial is computed fully pipelined (e.g., on an FPGA or hardware accelerator) and requires half of the surface area of the existing approach.

Many functions requiring approximation have Taylor polynomial or other polynomial approximations with “simple” fraction coefficients. As used herein, “simple” fractions refer to fractions with the numerator and denominator represented by a small number of single bits. For example, some Taylor series approximations include:

$$exp ( x ) = 1 + x + ( 1 / 2 ) {x}^{2} + ( 1 / 6 ) {x}^{3} + … \\ sin ( x ) = x - ( 1 / 6 ) {x}^{3} + … \\ cos ( x ) = 1 - ( 1 / 2 ) {x}^{2} + … \\ log ( 1 + x ) = ( 1 / 2 ) {x}^{2} - ( 1 / 3 ) {x}^{3} - … \\ a tan ( x ) = x - ( 1 / 3 ) {x}^{3} + ( 1 / 5 ) {x}^{5} … \\ tanh ( x ) = x - ( 1 / 3 ) {x}^{3} + ( 2 / 15 ) {x}^{5} …$$

Further approximations can be optimized with a constraint that they have such “simple” coefficients. Furthermore, these approximations are often used with small inputs, e.g., |x|< 1/256. This is true for most table-based piecewise approximations.

In most cases in which the coefficients are representable in binary with a small number of 1 bits, and especially when they are representable with a single 1 bit (i.e., they are a power of 2) and the input is small, some of the operations in the Horner evaluation are trivial. For example, (1+x) when evaluated in fixed-point (which floating-point units perform after normalization) never carries a bit because every bit-wise addition has at least one zero argument. Such additions are equivalent to a bitwise OR operation, and even the OR operation is not necessary because they are effectively computed by concatenating bits as part of marshalling arguments for the next operation. For example, in an embodiment 2(1+x+(½)x²) is computed as concatenate (2, (x<<1)+x*x), which is executed by a single modified fixed-point multiply-add operation.

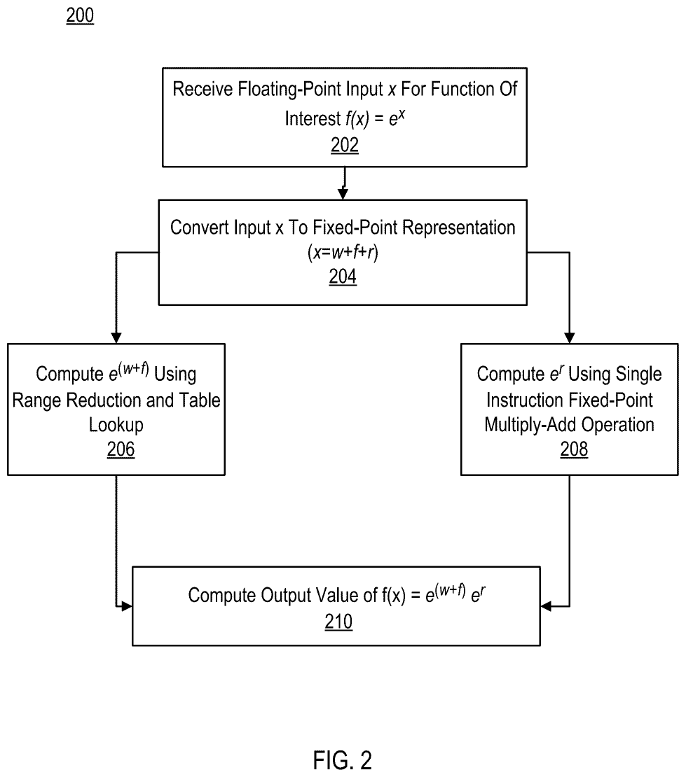

FIG. 2 is a flowchart of an example method 200 for deep fraction polynomial evaluation according to embodiments of the present disclosure. In the example of FIG. 2, a function of interest for evaluation is f(x)=e^{x}. The method 200 includes receiving 202, by the polynomial computation logic 124, a floating-point input x for the function of interest f(x)=e^{x}. The polynomial computation logic 124 converts 204 the input x to a fixed point-representation of x=w+f+r in which w is a whole number portion, f is a leading fraction bits portion, and r is a remaining fraction bits portion. Accordingly, the function e^{x} may be rewritten as e^{w+f+r}=e^{w+f}e^{r}. In the particular embodiment, the terms e^{w+f} and e^{r} are separately calculated and combined to compute an output value for the function of interest and further described below.

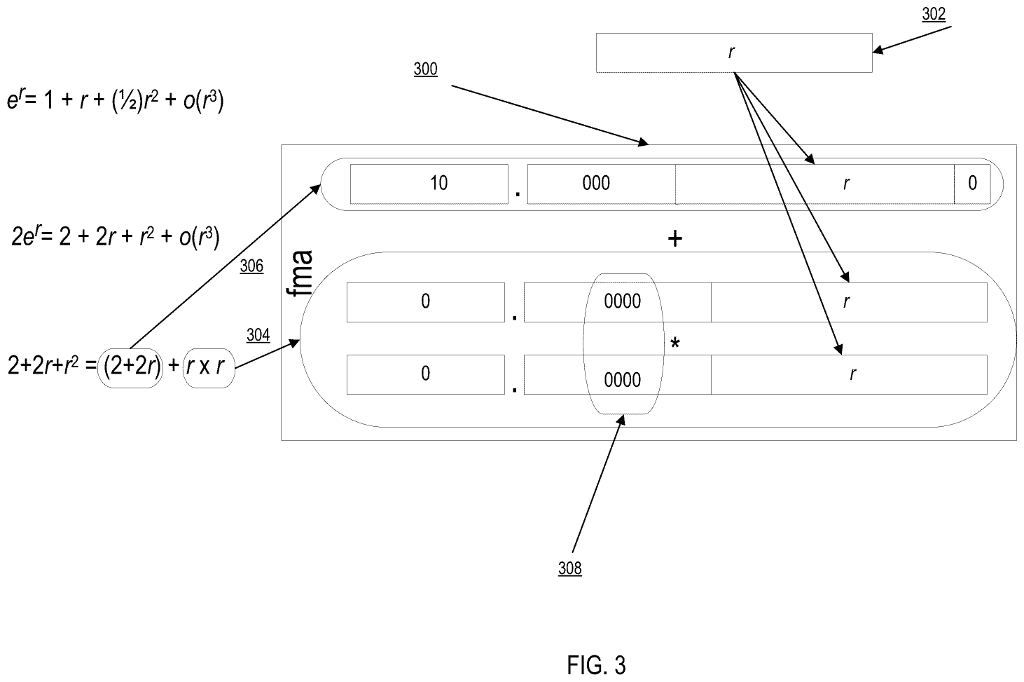

The method 200 further includes computing 206, by the polynomial computation logic 124, the term e^{w+f}=2 log₂^{(e)(w+f)}. In particular embodiments, the term e^{w+f} is computed using existing techniques known to those in the art such as range reduction and table lookup. For example, the whole number portion w and leading fraction bits portion f may be used as indexes to one or more lookup tables to evaluate the term e^{w+f}. The method 200 further includes computing 208, by the polynomial computation logic 124, the term e^{r} using a single instruction fixed-point multiply-add operation in accordance with one or more embodiments as further described below with respect to FIG. 3.

Referring now to FIG. 3, FIG. 3 shows an example of a hardware instruction for deep fraction polynomial evaluation according to embodiments of the present disclosure. FIG. 3 illustrates a new hardware instruction 300 for computing a modified FMA configured to evaluate a deep fraction polynomial. In the example of FIG. 3, the function of interest may be rewritten for evaluation using the hardware instruction 300 as follows:

$${e}^{r} = 1 + r + ( 1 / 2 ) {r}^{2} + O ( {r}^{3} ) \\ 2 {e}^{r} = 2 + 2 r + {r}^{2} + O ( {r}^{3} ) \\ 2 + 2 r + {r}^{2} = ( 2 + 2 r ) + r \times r$$

The hardware instruction 300 is based on an existing FMA instruction which computes a+b*c, but instead of taking a, b, and c as inputs, the new hardware instruction 300 takes the remaining fraction bits portion r as an input 302. The input r forms a, b, and c according to the pattern shown in the hardware instruction 300 in which the input bits of r are inserted into the bits marked r shown in the hardware instruction 300. Zero bits 308 are inserted after the binary point in the b and c operands 304 of the FMA according to an operand that specifies the number of zeros (0s) needed (e.g., N zeros). In particular embodiments, the number of zero bits 308 are referenced from a table associating a particular number of bits with a particular function of interest. In particular embodiments, the value of N depends on a table size needed for the function on interest that is desired to be approximated. This operand of the instruction can be immediate since it depends only on the function and not on the arguments of the function. The a argument 306 to the FMA is formed by inserting a “1” to the left of the binary point, then N zeroes, then r, and finally shifting left by another immediate operand. In the example illustrated in FIG. 3, the left shift is 1, resulting in a value of “10” to the left of the binary point, and an extra “0” to the right of r, since r is shifted left by 1. As a result, the value of e^{r} is calculated using the single hardware instruction 300.

Returning again to FIG. 2, the polynomial computation logic 124 computes 210 an output value of f(x)=e^{(w+f)}e^{r} for the input x by multiplying the computed result of e^{(w+f)} with the computed result of e^{r}. As a result, the FMA instruction 300 computes three terms in the time of one floating-point operation and saves one FMA operation per polynomial compared to using Horner's rule.

The new hardware instruction 300 may be used for different functions by changing the immediate operands controlling the amount of shift and number N of zero values. Accordingly, these immediate operands depend only on the functions, not the arguments to the functions. In particular embodiments, the polynomial computation logic 124 may utilize existing adders and multipliers within a floating-point unit (FPU) and utilize fixed bit shifts in which the amount of shift depends on the function rather than the data.

In some embodiments, a condition that the value x is positive is relaxed at the expense of added circuit complexity. In other embodiments, subtraction operations are avoided, e.g., −1+x is computed instead of 1−x. In other embodiments, −1+x is formed by concatenating bits. In some embodiments, addition is eliminated. For example, 1+x+x², where 0<x<2\hat{ }(−12) and x is a fixed-point fraction with up to 23 fraction bits (i.e., the result of converting a single precision floating point number into a fixed point) is computed by concatenating the bits for 1, x, and x\hat{ }2 because 0<x\hat{ }2<2\hat{ }24, so x and x\hat{ }2 have no overlapping non-zero bits.

Although certain embodiments have utilized particular functions of interest as examples, other embodiments may utilize more general operations than that of a fixed shift of r shown in the examples. For example, another function may require multiplication by 5, which may be accomplished by a shift of two, followed by an addition. In other embodiments, any number represented in binary bits may be efficiently calculated by a small circuit. The exact number of 1 bits which are supported depend on the clock cycle, design of the FMA engine, and capabilities of a target fabrication process. In addition, the b and c inputs may be shifted or multiplied by a small number, and the sign of any of a, b, and c may also be changed since FMA engines provide such support.

Various embodiments may be implemented in a number of different ways such as utilizing hardware accelerators or FPGAs. In this case, the fixed-point multipliers and adders are chained together with connecting circuits configured to encode the required bit shifts. For constants encoded using multiple bits, additional shifts and adders are inserted to effect multiplication by these constants at a low cost relative to the use of multipliers. Depending on the particular application, denominators may be multiplied out so that constants are all integers and the result is a multiple of the required value to use fixed-point computations with fractions without losing precession through intermediate rounding.

In other embodiments that are implemented on a CPU, new instructions are added to take prescribed, optionally shifted bit fields from normalized input arguments, and used in different positions in a multiply, add, or multiply-add with prescribed left-shifts at intermediate steps. In particular embodiments, the number of allowed shift values are restricted to a small number of values. In some embodiments, complex polynomials are evaluated by pipelining the instructions through the floating-point execution unit multiple times as a multi-cycle instruction. Alternately, the computation is broken into multiple instructions, each of which are mapped onto the floating-point execution unit or a simpler execution unit.

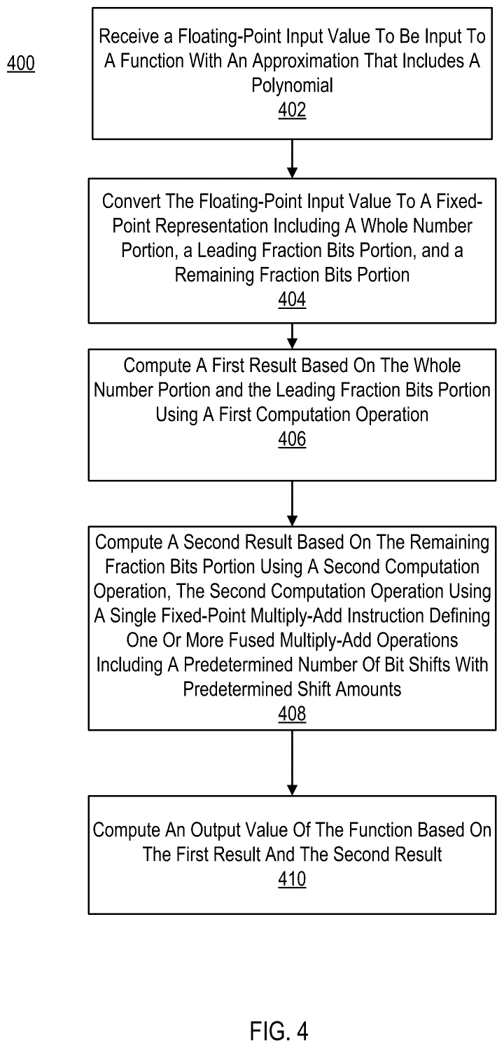

FIG. 4 is a flowchart of another example method 400 for deep fraction polynomial evaluation according to embodiments of the present disclosure. The method 400 includes receiving 402 a floating-point input value to be input to a function with an approximation that includes a polynomial. In an embodiment, the polynomial approximation includes a Taylor polynomial.

The method further includes converting 404 the floating-point input value to a fixed-point representation including a whole number portion, a leading fraction bits portion, and a remaining fraction bits portion. The method 400 further includes computing 406, by the polynomial computation logic 124, a first result based on the whole number portion and the leading fraction bits portion using a first computation operation. In an embodiment, the first computation operation uses one or more of a table lookup and a range reduction.

The method 400 further includes computing 408, by the polynomial computation logic 124, a second result based on the remaining fraction bits portion using a second computation operation, the second computation operation using a single fixed-point multiply-add instruction defining a fused multiply-add operation including a predetermined number of bit shifts with predetermined shift amounts. In an embodiment, the fused multiply-add operation further includes at least one of a concatenation operation, a multiplication operation, an addition operation, and a multiplication-addition operation. In an embodiment, the predetermined number of bit shifts with predetermined shift amounts are based on the function.

The method 400 further includes computing 410 an output value of the function based on the first result and the second result.

In an embodiment, the location within the input bits of the remaining fraction bits of the input are chosen so that their place values are less than a predetermined value.

In an embodiment, the coefficients of the polynomials are fractions whose numerators and denominators are sums of small numbers of powers of two.

In view of the explanations set forth above, readers will recognize that the benefits of hardware-implemented deep fraction polynomial evaluation according to embodiments of the present disclosure include:
Improved latency for polynomial evaluation operations.
More efficient computation of polynomial evaluations.
A reduced number of instructions required for polynomial evaluation.
More compact hardware implementation of polynomial evaluation operations.

Exemplary embodiments of the present disclosure are described largely in the context of a fully functional computer system for hardware-implemented deep fraction polynomial evaluation. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for deep fraction polynomial evaluation, the method comprising:
receiving a floating-point input value to be input to a function with an approximation that includes a polynomial;
converting the floating-point input value to a fixed-point representation including a whole number portion, a leading fraction bits portion, and a remaining fraction bits portion;
computing a first result based on the whole number portion and the leading fraction bits portion using a first computation operation;
computing a second result based on the remaining fraction bits portion using a second computation operation, the second computation operation using a single fixed-point multiply-add instruction defining one or more fused multiply-add operations including a predetermined number of bit shifts with predetermined shift amounts; and
computing an output value of the function based on the first result and the second result.

2. The method of claim 1, wherein the fused multiply-add operation further includes at least one of a concatenation operation, a multiplication operation, an addition operation, and a multiplication-addition operation.

3. The method of claim 1, wherein the remaining fraction bits portion of the input value satisfies a first constraint.

4. The method of claim 3, wherein the first constraint includes that the remaining fraction bits portion of the input value is less than a predetermined value.

5. The method of claim 1, wherein coefficients of the polynomial approximation satisfy a second constraint.

6. The method of claim 5, wherein the second constraint includes that the coefficients of the polynomials are fractions whose numerators and denominators are sums of a small number of powers of two.

7. The method of claim 1, wherein the predetermined number of bit shifts with predetermined shift amounts are based on the function.

8. The method of claim 1, wherein the first computation operation uses one or more of a table lookup and a range reduction.

9. The method of claim 1, wherein the polynomial approximation includes a Taylor polynomial approximation.

10. An apparatus for deep fraction polynomial evaluation, the apparatus comprising:
a processor; a computer memory operatively coupled to the processor; and
logic configured to cause the apparatus to:
receive a floating-point input value to be input to a function with an approximation that includes a polynomial;
convert the floating-point input value to a fixed-point representation including a whole number portion, a leading fraction bits portion, and a remaining fraction bits portion;
compute a first result based on the whole number portion and the leading fraction bits portion using a first computation operation;
compute a second result based on the remaining fraction bits portion using a second computation operation, the second computation operation using a single fixed-point multiply-add instruction defining one or more fused multiply-add operations including a predetermined number of bit shifts with predetermined shift amounts; and
compute an output value of the function based on the first result and the second result.

11. The apparatus of claim 10, wherein the fused multiply-add operation further includes at least one of a concatenation operation, a multiplication operation, an addition operation, and a multiplication-addition operation.

12. The apparatus of claim 10, wherein the logic is further optimized to take advantage of the input value satisfying a first constraint.

13. The apparatus of claim 12, wherein the first constraint includes that the remaining fraction bits portion of the floating-point input value is less than a predetermined value.

14. The apparatus of claim 10, wherein coefficients of the polynomial approximation satisfy a second constraint.

15. The apparatus of claim 14, wherein the second constraint includes that the coefficients of the polynomials are fractions whose numerators and denominators are sums of a small number of powers of two.

16. The apparatus of claim 10, wherein the predetermined number of bit shifts with predetermined shift amounts are based on the function.

17. The apparatus of claim 10, wherein the first computation operation uses one or more of a table lookup and a range reduction.

18. The apparatus of claim 10, wherein the polynomial approximation includes a Taylor polynomial approximation.

19. A computer program product for deep fraction polynomial evaluation, the computer program product disposed upon a computer readable medium, the computer program product comprising computer program instructions that, when executed, cause a computer to:
receive a floating-point input value to be input to a function with an approximation that includes a polynomial;
convert the floating-point input value to a fixed-point representation including a whole number portion, a leading fraction bits portion, and a remaining fraction bits portion;
compute a first result based on the whole number portion and the leading fraction bits portion using a first computation operation;
compute a second result based on the remaining fraction bits portion using a second computation operation, the second computation operation using a single fixed-point multiply-add instruction defining one or more fused multiply-add operations including a predetermined number of bit shifts with predetermined shift amounts; and
compute an output value of the function based on the first result and the second result.

20. The computer program product of claim 19, wherein the fused multiply-add operation further includes at least one of a concatenation operation, a multiplication operation, an addition operation, and a multiplication-addition operation.
